(19) United States
(12) Patent Application Publication
(10) Pub. No.: US 2011/0065848 A1
(43) Pub. Date: Mar. 17, 2011

(54) Flame Retardant Polycarbonate Resin Composition

(75) Inventors: Hyuk-Jin JUNG, Gunpo-si (KR); Jong-Cheol LIM, Anyang-si (KR); Sang-Hwa LEE, Seoul (KR)

(73) Assignee: CHEIL INDUSTRIES INC., Gumi-si (KR)

(21) Appl. No.: 12/944,996

(22) Filed: Nov. 12, 2010

Related U.S. Application Data
(63) Continuation-in-part of application No. PCT/KR2008/007904, filed on Dec. 31, 2008.

(30) Foreign Application Priority Data
May 14, 2008 (KR) 10-2008-0044706

(51) Int. Cl. C08K 5/42

(52) U.S. Cl. 524/162; 524/166

(57) ABSTRACT

The flame retardant polycarbonate resin composition of the present invention includes (A) a polycarbonate resin, (B) a rubber-modified vinyl-based graft copolymer, (C) a metal salt of sulfonic acid, and (D) an anti-drip agent including a fluorinated terpolymer. The polycarbonate resin composition of the present invention can have excellent flame retardancy, heat resistance, and mechanical strength, well-balanced mechanical properties such as impact resistance, heat resistance, and fine workability, and an excellent appearance characteristic. Therefore, it can be useful for fabrication of molded products such as electric household appliances, office appliances, electrical and electronic devices, and internal parts thereof.

### CROSS REFERENCE TO RELATED APPLICATIONS

This application is a continuation-in-part of International Application No. PCT/KR2008/007904, filed Dec. 31, 2008, pending, which designates the U.S., published as WO 2009/139534, and is incorporated herein by reference in its entirety, and claims priority therefrom under 35 USC Section 120. This application also claims priority under 35 USC Section 119 from Korean Patent Application No. 10-2008-0044706, filed May 14, 2008, in the Korean Intellectual Property Office, the entire disclosure of which is also incorporated herein by reference.

### FIELD OF THE INVENTION

The present invention relates to a flame retardant polycarbonate resin composition.

### BACKGROUND OF THE INVENTION

Polycarbonate resin can be used in a variety of applications, such as office automative devices, communication devices, and electrical and electronic products, due to its transparency, excellent electrical characteristics, and fine mechanical properties, e.g., high resistance against impact.

Resin compositions used for office automation devices and electrical and electronic products typically must comply with strict safety specifications, including flame retardancy requirements. One method for imparting flame retardancy to a resin composition includes adding a flame retardant agent such as a halogen-containing compound, a phosphorous-containing compound, a metal salt of a sulfonic acid compound, or a silicon-based compound to the resin.

U.S. Pat. Nos. 4,983,658 and 4,883,835 disclose examples of a halogen-containing compound used as a flame retardant, U.S. Pat. Nos. 5,061,745 and 4,883,835 disclose examples of a phosphorous-containing compound used as a flame retardant, U.S. Pat. Nos. 3,535,300 and 3,775,367 disclose examples of a metal salt of sulfonic acid used as a flame retardant, and U.S. Pat. Nos. 3,971,756 and 6,001,921 disclose examples of a silicon-based compound used as a flame retardant.

A flame retardant polycarbonate resin composition with a flame retardant agent and an anti-drip agent, such as a fluorinated polyolefin, is generally used to provide flame retardancy properties to products with reduced thicknesses (i.e., thinner products). A polyolefin-based resin can form a fibrillar network. Therefore, when the polyolefin-based resin is used as an anti-drip agent for a polycarbonate resin composition, fine pitting and/or silver streaking can occur in the surface of molded products, which is problematic.

To overcome this problem, U.S. Pat. No. 4,649,168 discloses an example of using a coagulation mixture of emulsions of fluorinated polyethylene and a styrene-containing copolymer as an anti-drip agent for a polycarbonate resin composition also including a metal salt of sulfonic acid as a flame retardant. However, it can be complicated to prepare the coagulation mixture, which can increase production costs. Also, the content of the fluorinated polyethylene is relatively small. Therefore, when the coagulation mixture is used as an anti-drip agent, it should be used in an amount greater than the amount of fluorinated polyethylene typically used alone, which can also be problematic.

U.S. Pat. No. 6,180,702 discloses an example of using a coagulation mixture of fluorinated polyethylene and poly(meth)acrylic acid alkyl ester resin as an anti-drip agent for a polycarbonate resin composition which also includes a metal salt of sulfonic acid as a flame retardant.

When the coagulation mixture is used as an anti-drip agent, the dispersion property of a resin composition can improve, which can improve appearance problems such as fine pitting and/or silver streaking to some extent. However, the flame retardancy of the resin composition can be deteriorated compared to that of composition using a typical fluorinated polyethylene-based resin as an anti-drip agent.

### SUMMARY OF THE INVENTION

An embodiment of the present invention provides a polycarbonate resin composition that can have excellent flame retardancy without decreasing mechanical and appearance characteristics.

Another embodiment of the present invention provides a polycarbonate resin composition that can have balanced mechanical properties such as heat resistance, impact strength, and workability.

Yet another embodiment of the present invention provides a molded product fabricated using the polycarbonate resin composition.

The embodiments of the present invention are not limited to the above technical purposes, and a person of ordinary skill in the art can understand other technical purposes.

According to one embodiment of the present invention, a flame retardant polycarbonate resin composition is provided that includes: (A) a polycarbonate resin; (B) a rubber-modified vinyl-based graft copolymer; (C) a metal salt of sulfonic acid; and (D) an anti-drip agent including a fluorinated terpolymer including a repeating unit represented by the following Chemical Formula 1.

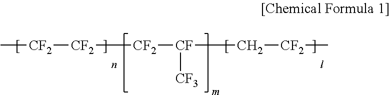

In the above Chemical Formula 1, each of n, m, and l refers to a mole ratio of the repeating units, where n ranges from 15 to 50, m ranges from 20 to 40, and l ranges from 30 to 60.

According to another embodiment of the present invention, a molded product fabricated using the polycarbonate resin composition is provided.

Hereinafter, further embodiments of the present invention will be described in detail.

The polycarbonate resin composition of the present invention can have excellent flame retardancy, heat resistance, and mechanical strength, well-balanced mechanical properties such as impact resistance, heat resistance, and fine workability, and an excellent appearance characteristic. Therefore, it can be useful for fabrication of molded products such as electric household appliances, office appliances, electrical and electronic devices, and internal parts thereof.

### DETAILED DESCRIPTION OF THE INVENTION

The present invention now will be described more fully hereinafter in the following detailed description of the invention and with reference to the accompanying drawing, in which some, but not all embodiments of the invention are described. Indeed, this invention may be embodied in many different forms and should not be construed as limited to the embodiments set forth herein; rather, these embodiments are provided so that this disclosure will satisfy applicable legal requirements.

As used herein, the terms “substituted alkyl,” “substituted alkylene,” “substituted alkylidene,” “substituted cycloalkylene,” “substituted cycloalkylidene,” “substituted aryl,” and “substituted arylene” refer to alkyl, alkylene, alkylidene, cycloalkylene, cycloalkylidene, aryl, and arylene, respectively, independently substituted with one or more of halogen, C1 to C30 alkyl, C6 to C30 aryl, C2 to C30 heteroaryl, or C1 to C20 alkoxy.

As used herein, when a specific definition is not otherwise provided, the term “alkyl” refers to C1 to C20 alkyl, the term “alkylene” refers to C1 to C20 alkylene, the term “aryl” refers to C6 to C30 aryl, the term “alkoxy” refers to C1 to C20 alkoxy, the term “alkenyl” refers to C1 to C20 alkenyl, the term “cycloalkane” refers to C3 to C20 cycloalkane, the term “alkylidene” refers to C1 to C20 alkylidene, the term “cycloalkylene” refers to C3 to C20 cycloalkylene, the term “cycloalkylidene” refers to C3 to C20 cycloalkylidene, and the term “arylene” refers to C6 to C30 arylene.

As used herein, when a specific definition is not otherwise provided, the term “hetero” refers to a group substituted with one or more heteroatoms such as one or more of N, O, S, or P, or a combination thereof.

The flame retardant polycarbonate resin composition according to one embodiment of the present invention includes (A) a polycarbonate resin, (B) a rubber-modified vinyl-based graft copolymer, (C) a metal salt of sulfonic acid, and (D) an anti-drip agent including a fluorinated terpolymer including the repeating unit represented by the following Chemical Formula 1.

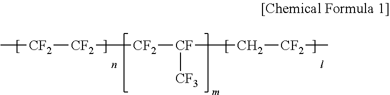

In the above Chemical Formula 1, each of n, m, and l refers to a mole ratio of the repeating unit, where n ranges from 15 to 50, m ranges from 20 to 40, and l ranges from 30 to 60.

In exemplary embodiments the polycarbonate resin composition can include 1 to 10 parts by weight of the rubber-modified vinyl-based graft copolymer (B), 0.01 to 3 parts by weight of the metal salt of sulfonic acid (C), and 0.01 to 3 parts by weight of the anti-drip agent including a fluorinated terpolymer including the repeating unit represented by the above Chemical Formula 1 based on 100 parts by weight of the polycarbonate resin (A).

Exemplary components included in the polycarbonate resin composition according to embodiments of the present invention will hereinafter be described in detail.

(A) Polycarbonate Resin

The polycarbonate resin is a base resin in the composition of the invention and may be prepared by reacting one or more diphenols of the following Chemical Formula 2 with a phosgene, a halogen formate, a carbonate diester, or a combination thereof.

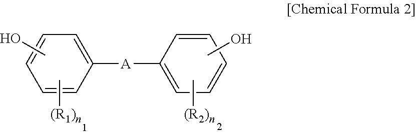

In the above Chemical Formula 2, A is a single bond, substituted or unsubstituted C1 to C5 alkylene, substituted or unsubstituted C1 to C5 alkylidene, substituted or unsubstituted C3 to C6 cycloalkylene, substituted or unsubstituted C5 to C6 cycloalkylidene, CO, S, or SO₂,

R₁ and R₂ are independently substituted or unsubstituted C1 to C30 alkyl or substituted or unsubstituted C6 to C30 aryl, and

nᵢ and n₂ are independently integers ranging from 0 to 4.

As used herein with reference to Chemical Formula 2, the term “substituted” refers to one substituted with one or more substituents selected from the group consisting of halogen, C1 to C30 alkyl, C1 to C30 haloalkyl, C6 to C30 aryl, C1 to C20 alkoxy, and combinations thereof.

The diphenols represented by the above Chemical Formula 2 may be used singly or in combinations to constitute repeating units of the polycarbonate resin. Specific examples of the diphenols include without limitation hydroquinone, resorcinol, 4,4′-dihydroxy diphenyl, 2,2-bis(4-hydroxyphenyl)-propane, 2,4-bis(4-hydroxyphenyl)-2-methylbutane, 1,1-bis(4-hydroxyphenyl)-cyclohexane, 2,2-bis(3-chloro-4-hydroxyphenyl)-propane, or 2,2-bis(3,5-dichloro-4-hydroxyphenyl)-propane. In exemplary embodiments, the diphenol can be 2,2-bis(4-hydroxyphenyl)-propane, 2,2-bis(3,5-dichloro-4-hydroxyphenyl)-propane, or 1,1-bis(4-hydroxyphenyl)-cyclohexane. In exemplary embodiments, the diphenol can be 2,2-bis(4-hydroxyphenyl)-propane (also referred to as bisphenol-A).

The polycarbonate resin can have a weight average molecular weight ranging from 10,000 to 200,000, for example a weight average molecular weight ranging from 15,000 to 80,000, but is not limited thereto.

The polycarbonate resin may be a linear polycarbonate such as a bisphenol-A-based polycarbonate resin. The polycarbonate resin may also be a branched polycarbonate resin prepared by further adding a multi-functional compound including three or more phenol groups in an amount of 0.05 to 2 mol % based on the total weight of the phenols during polymerization. The polycarbonate resin may also be partially or totally replaced by an aromatic polyester-carbonate resin that is obtained by polymerizing an ester precursor, for example difunctional carboxylic acid.

The polycarbonate resin may be a homo-polycarbonate resin or a co-polycarbonate resin, and the co-polycarbonate resin and homo-polycarbonate resin may also be used as a blend thereof.

The amounts of the components (B) to (E) in the resin composition of the present invention are based on 100 parts by weight of the polycarbonate resin (A).

(B) Rubber-Modified Vinyl-Based Graft Copolymer

The rubber-modified vinyl-based graft copolymer functions as an impact modifier in the resin composition. The rubber-modified vinyl-based graft copolymer is obtained by graft-copolymerizing (b₁) 5 to 95 parts by weight of a vinyl-based monomer into (b₂) 5 to 95 parts by weight of a rubbery polymer.

The vinyl-based monomer (b₁) includes (b₁₁) 50 to 95 parts by weight of a first vinyl-based monomer such as but not limited to styrene, a halogen-substituted styrene, an alkyl-substituted styrene such as alpha-methylstyrene, a methacrylic acid alkyl ester, an acrylic acid alkyl ester, and the like, and mixtures thereof, (b₁₂) 5 to 50 parts by weight of a second vinyl-based monomer such as but not limited to acrylonitrile, methacrylonitrile, a methacrylic acid alkyl ester, an acrylic acid alkyl ester, maleic anhydride, C₁-C₄ alkyl N-substituted maleimide, phenyl N-substituted maleimide, and the like, and mixtures thereof. The first and second vinyl-based monomers may be different from each other.

The alkyl substituted styrene includes a C₁ to C₈ alkyl.

The methacrylic acid alkyl esters and acrylic acid alkyl esters include a C₁ to C₈ alkyl. The methacrylic acid alkyl esters and acrylic acid alkyl esters are alkyl esters of methacrylic acid or acrylic acid, respectively. For example, C₁ to C₈ alkyl esters may be obtained from C₁ to C₈ monohydroxy alcohols. Examples of methacrylic acid alkyl esters and acrylic acid alkyl esters useful in the invention include without limitation methacrylic acid methyl ester, methacrylic acid ethyl ester, acrylic acid ethyl ester, acrylic acid methyl ester, methacrylic acid propyl ester, and the like, and mixtures thereof. In exemplary embodiments, methacrylic acid methyl ester can be used.

The rubbery polymer (b₂) may include without limitation butadiene rubber, acrylic rubber, ethylene/propylene rubber, styrene/butadiene rubber, acrylonitrile/butadiene rubber, isoprene rubber, ethylene-propylene-diene terpolymer (EPDM), polyorganosiloxane/polyalkylmethacrylate rubber composite, the like, and mixtures thereof.

When the graft copolymer is prepared, the rubbery polymer may have a particle diameter of 0.05 to 4 μm to improve the impact strength and the surface characteristic of a molded product.

Exemplary rubber-modified vinyl-based graft copolymers useful in the invention may be obtained by graft-copolymerizing a styrene/acrylonitrile vinyl-based monomer or a methacrylic acid alkyl ester monomer, or mixtures thereof, to a butylacrylate rubber.

Other exemplary rubber-modified vinyl-based graft copolymers useful in the invention may also be obtained by graft-copolymerizing a methacrylic acid methyl ester monomer, or optionally an acrylic acid methyl ester or acrylic acid ethyl ester monomer, to an acrylic rubber or polyorganosiloxane/polyalkyl(meth)acrylate rubber polymer.

Methods for preparing rubber-modified vinyl-based graft copolymers are widely known to those skilled in the art to which the present invention pertains, and any one among emulsion polymerization, suspension polymerization, solution polymerization, and bulk polymerization can be used to prepare the rubber-modified vinyl-based graft copolymer. In exemplary embodiments, the rubber-modified vinyl-based graft copolymer can be prepared by emulsion polymerization or bulk polymerization by inputting the vinyl-based monomer in the presence of a rubbery polymer and using a polymerization initiator.

The rubber-modified vinyl-based graft copolymer may be used in an amount of 1 to 10 parts by weight, based on 100 parts by weight of the (A) polycarbonate resin. In some embodiments, the rubber-modified vinyl-based graft copolymer may be used in an amount of 1, 2, 3, 4, 5, 6, 7, 8, 9, or 10 parts by weight. Further, according to some embodiments of the present invention, the amount of the rubber-modified vinyl-based graft copolymer can be in a range from any of the foregoing amounts to any other of the foregoing amounts. When the amount of the rubber-modified vinyl-based graft copolymer is less than 1 part by weight, the impact resistance may be deteriorated. When the amount of the rubber-modified vinyl-based graft copolymer exceeds 10 parts by weight, flame retardancy and heat resistance may be deteriorated. Use of the rubber-modified vinyl-based graft copolymer in an amount within the above range can provide a balance of impact resistance, flame retardancy, and heat resistance properties.

### (C) Metal Salt of Sulfonic Acid

The metal salt of sulfonic acid may include (C₁) a metal salt of aromatic sulfonic acid, (C₂) a metal salt of perfluoroalkane sulfonic acid, or a mixture thereof. Exemplary components will hereinafter be described in detail.

(C₁) Metal Salt of Aromatic Sulfonic Acid

The metal salt of aromatic sulfonic acid may be represented by the following Chemical Formula 3.

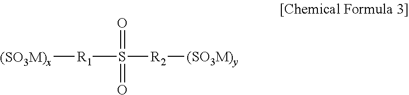

In the above Chemical Formula 3, R₁ and R₂ are independently a C₁ to C₆ aliphatic group, phenyl, biphenyl, alkyl-substituted phenyl, or a combination thereof, x is an integer ranging from 0 to 6, y is an integer ranging from 1 to 6, and M is a metal cationic group. As used in Chemical Formula 3, the term “C₁ to C₆ aliphatic group” refers to C1 to C6 alkylene, C2 to C6 alkenylene, or C2 to C6 alkynylene.

Examples of M can include without limitation Group I metals (alkali metals) such as sodium, potassium, and the like, Group II metals (alkaline-earth metals), copper, aluminum, and the like, and combinations thereof. In exemplary embodiments, M includes an alkali metal.

Exemplary metal salts of aromatic sulfonic acid represented by the above Chemical Formula 3 include without limitation metal salts of diphenylsulfone-3-sulfonic acid, metal salts of diphenylsulfone-3,3′-disulfonic acid, metal salts of diphenylsulfone-3,4′-disulfonic acid, and the like, and mixtures thereof. Exemplary metals include without limitation Group I metals (alkali metals) such as sodium, potassium, and the like, Group II metals (alkaline-earth metals), copper, aluminum, and the like, and combinations thereof. In exemplary embodiments, the metal includes an alkali metal.

As a non-limiting example, the metal salt of aromatic sulfonic acid represented by the above Chemical Formula 3 may be potassium diphenylsulfone-3-sulfonate.

(C₂) Metal Salt of Perfluoroalkane Sulfonic Acid

The metal salt of perfluoroalkalane sulfonic acid may be represented by the following Chemical Formula 4.

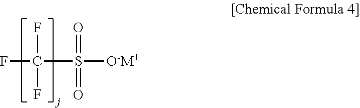

In the above Chemical Formula 4, M is a metal cationic group, and j is an integer ranging from 1 to 8.

Examples of M can include without limitation Group I metals (alkali metals) such as sodium, potassium, and the like, Group II metals (alkaline-earth metals), copper, aluminum, and the like, and combinations thereof. In exemplary embodiments, the metal includes an alkali metal.

Exemplary metal salts of perfluoroalkane sulfonic acid of the above Chemical Formula 4 include without limitation metal salts of perfluoromethane sulfonic acid, metal salts of perfluoroethane sulfonic acid, metal salts of perfluoropropane sulfonic acid, metal salts of perfluorobutanesulfonic acid, metal salts of perfluoropentane sulfonic acid, metal salts of perfluorohexane sulfonic acid, metal salts of perfluoroheptane sulfonic acid, metal salts of perfluorooctane sulfonic acid, and the like, and mixtures thereof. Exemplary metals include without limitation Group I metals (alkali metals) such as sodium, potassium, and the like, Group II metals (alkaline-earth metals), copper, aluminum, and the like, and combinations thereof. In exemplary embodiments, the metal includes an alkali metal. Exemplary metal salts of perfluoroalkane sulfonic acid may include without limitation potassium fluorobutane sulfonate.

The metal salt of sulfonic acid may be included in an amount of 0.01 to 3 parts by weight, based on 100 parts by weight of the (A) polycarbonate resin. In some embodiments, the metal salt of sulfonic acid may be used in an amount of 0.01, 0.02, 0.03, 0.04, 0.05, 0.06, 0.07, 0.08, 0.09, 0.1, 0.2, 0.3, 0.4, 0.5, 0.6, 0.7, 0.8, 0.9, 1, 2, or 3 parts by weight. Further, according to some embodiments of the present invention, the amount of the metal salt of sulfonic acid can be in a range from any of the foregoing amounts to any other of the foregoing amounts. When the amount of the metal salt of sulfonic acid is less than 0.01 parts, flame retardancy may not be sufficiently improved. When the amount of the metal salt of sulfonic acid exceeds 3 parts, thermal stability may be deteriorated at a high temperature. Use of the metal salt of sulfonic acid in an amount within the above range can improve flame retardancy and thermal stability.

(D) Anti-Drip Agent

The anti-drip agent can help increase flame retardancy of thinner products (i.e., products with a reduced thickness). In the resin composition prepared according to an embodiment of the present invention, the anti-drip agent may be a fluorinated terpolymer including a repeating unit of the following Chemical Formula 1.

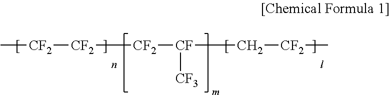

In the above Chemical Formula 1, each of n, m, and l refers to a mole ratio (mol %) of a repeating unit. Specifically, n ranges from 15 to 50, m ranges 20 to 40, and l ranges from 30 to 60.

The fluorinated terpolymer may be prepared using known polymerization methods. For example, the fluorinated terpolymer may be prepared in an aqueous medium including a free radical forming catalyst such as sodium, potassium, or ammonium peroxydisulfate at a temperature of 0 to 200° C., for example from 20 to 100° C., under a pressure of 7 to 71 kg/cm².

The anti-drip agent may further include a fluorinated polyolefin-based resin along with the fluorinated terpolymer.

Exemplary fluorinated polyolefin-based resins include without limitation polytetrafluoroethylene, polyvinylidene fluoride, a tetrafluoroethylene/vinylidene fluoride copolymer, a tetrafluoroethylene/hexafluoropropylene copolymer, an ethylene/tetrafluoroethylene copolymer, and the like, and mixtures thereof.

The fluorinated polyolefin-based resin forms a fibrillar network in the resin to thereby decrease flow viscosity of the resin and increase shrinkage during combustion, when it is mixed with another resin containing different components from the fluorinated polyolefin-based resin and extruded. Essentially, it prevents the resin from dripping.

When used together with the fluorinated polyolefin-based resin, the fluorinated polyolefin-based resin and the fluorinated terpolymer may be mixed and used in a weight ratio of 50:50 to 90:10, for example in a weight ratio of 70:30 to 90:10.

When the fluorinated polyolefin-based resin and the fluorinated terpolymer are mixed in the above weight ratio range, it is possible to improve the dispersion property of the resin composition and the appearance characteristics (that is, minimize or eliminate pitting and/or silver streaking), as well as to increase the flame retardancy of the resin composition. Therefore, in exemplary embodiments the fluorinated polyolefin-based resin and the fluorinated terpolymer can be mixed in the above weight ratio range to balance the appearance characteristics and the flame retardancy.

The above-mentioned anti-drip agent may have a particle size of 0.05 to 1000 μm. When the particle size of the anti-drip agent is outside of the particle size range, pitting and/or silver streaking may occur. Therefore, in exemplary embodiments, the particle size of the anti-drip agent can be in the above range to provide desired appearance characteristics.

Also, the anti-drip agent may have a specific gravity of 1.2 to 2.3 g/cm³.

The anti-drip agent may be of an emulsion type or a powder type. An emulsion-type anti-drip agent can be well dispersed in the resin composition, but its preparation process may be somewhat complicated. Thus, exemplary embodiments may use a powder-type anti-drip agent to simplify the process. When the anti-drip agent is of a powder type, it should be sufficiently dispersed in the resin composition to form a fibrillar network.

The anti-drip agent may be included in an amount of 0.01 to 3 parts by weight, based on 100 parts by weight of the polycarbonate resin (A). In some embodiments, the anti-drip agent may be used in an amount of 0.01, 0.02, 0.03, 0.04, 0.05, 0.06, 0.07, 0.08, 0.09, 0.1, 0.2, 0.3, 0.4, 0.5, 0.6, 0.7, 0.8, 0.9, 1, 2, or 3 parts by weight. Further, according to some embodiments of the present invention, the amount of the anti-drip agent can be in a range from any of the foregoing amounts to any other of the foregoing amounts. Use of the anti-drip agent in an amount within this range can provide a resin composition with a good balance of mechanical properties, such as both increased flame retardancy and excellent impact strength.

(E) Other Additive(s)

The polycarbonate resin composition may further include one or more additional additive(s) including without limitation an ultraviolet (UV) stabilizer, a fluorescent whitening agent, a lubricant, a release agent, a nucleating agent, an antistatic agent, a stabilizer, a reinforcing material, an inorganic material additive, a colorant such as a pigment or a dye, and the like, and combinations thereof along with the above (A) to (D) components, according to its use.

The ultraviolet (UV) stabilizer can suppress a color change and a decrease in photo-reflectivity of the resin composition that may be caused by UV irradiation. Examples of the UV stabilizer include without limitation benzotriazole-based compounds, benzophenone-based compounds, triazine-based compounds, and the like, and combinations thereof.

The fluorescent whitening agent can improve photo-reflectivity of a polycarbonate resin composition. Examples of the fluorescent whitening agent include without limitation stilbene-bisbenzoxazole derivatives such as 4-(benzoxazol-2-yl)-4′-(5-methylbenzoxazol-2-yl)stilbene and 4,4′-bis(benzooxazol-2-yl)stilbene, and the like, and combinations thereof.

Exemplary release agents can include without limitation fluorine-containing polymers, silicone oils, metal salts of stearate, metal salts of montanic acid, ester waxes or polyethylene waxes of montanic acid, and the like, and combinations thereof.

Exemplary nucleating agents include without limitation talc, clay, and the like, and combinations thereof.

Exemplary inorganic material additives include without limitation glass fiber, silica, clay, calcium carbonate, calcium sulfate, glass beads, and the like, and combinations thereof.

The additive(s) may be used in an amount of not more than 60 parts by weight, for example 1 to 40 parts by weight, based on 100 parts by weight of the (A) polycarbonate resin. In some embodiments, the additive(s) may be used in an amount of 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, or 60 parts by weight. Further, according to some embodiments of the present invention, the amount of the additive(s) can be in a range from any of the foregoing amounts to any other of the foregoing amounts. When the additive is used in an amount within the above range, balanced mechanical properties can be acquired.

A polycarbonate resin composition having the above-mentioned composition may be prepared in a known method for preparing a resin composition. For example, a polycarbonate resin composition can be prepared in pellet form by simultaneously mixing the above-mentioned components and optionally other additive(s), and melting and extruding the mixture in an extruder. The pellets may be subject to conventional molding processes, such as but not limited to extrusion molding, injection molding, and the like, to form a product.

The polycarbonate resin composition may be used for molding diverse products, such as but not limited to external parts of electrical and electronic produces such as TVs, computers, mobile phones, and office automation devices, and precise parts for automobiles, which require superb mechanical and appearance characteristics with excellent flame retardancy.

Hereinafter, the present invention is illustrated in more detail with reference to examples. However, the embodiments of the present invention are exemplary, and the present invention is not limited thereto.

### EXAMPLES

Components of polycarbonate resin compositions used in the examples of the present invention and comparative examples are as follows.

(A) Polycarbonate resin

A bisphenol-A type polycarbonate having a weight average molecular weight of 25,000 g/mol, PANLITE L-1250WP of Teijin Company, Japan, is used.

(B) Rubber-modified vinyl-based graft copolymer

Metablen C223A of Mitsubishi Rayon Chemical Company, Japan, is used.

(C) Metal salt of sulfonic acid

(C-1) KSS (potassium diphenylsulfone-3-sulfonate) of Seal Sand Chemical Company, England, is used.

(C-2) FR-2025 (potassium perfluorobutane-sulfonate) of 3M, U.S., is used.

(D) Anti-drip agent

(D-1) A mixture of a powder-type polytetrafluoroethylene and fluorinated terpolymer (in a mixing weight ratio range of 7:3 to 8:2), MM5935EF of 3M Company, U.S., is used.

(D-2) A powder-type polytetrafluoroethylene, 850-A of DuPont Company, U.S., is used.

(D-3) An emulsion-type polytetrafluoroethylene, FR-301 B of 3F Company, China, is used.

(D-4) A mixed co-coagulation of a powder-type polyethylene and a styrene-containing copolymer, AD-541 of 3F Company, China, is used.

### Examples 1 and 2 and Comparative Examples 1 to 6

The components are mixed in a typical mixer according to the compositions shown in the following Table 1. The mixtures are extruded using a twin screw extruder with L/D=35 and φ=45 mm, and the extrusions are prepared in a pellet shape.

Specimens for measuring mechanical properties and evaluating flame retardancy at an injection temperature of 280 to 300° C. are fabricated using a 10 oz injection molding device and the prepared pellets.

TABLE 1
(unit: parts by weight)

| | | Examples | | Comparative Examples | | | | | |
|---|---|---|---|---|---|---|---|---|---|
| | | 1 | 2 | 1 | 2 | 3 | 4 | 5 | 6 |
| (A) | | 100 | 100 | 100 | 100 | 100 | 100 | 100 | 100 |
| (B) | | 4 | 4 | 4 | 4 | 4 | 4 | 4 | 4 |
| (C) | C-1 | 0.3 | — | 0.3 | 0.3 | 0.3 | — | — | — |
| | C-2 | — | 0.1 | — | — | — | 0.1 | 0.1 | 0.1 |
| (D) | D-1 | 0.4 | 0.4 | — | — | — | — | — | — |
| | D-2 | — | — | 0.4 | — | — | 0.4 | — | — |
| | D-3 | — | — | — | 0.6 | — | — | 0.6 | — |
| | D-4 | — | — | — | — | 0.6 | — | — | 0.6 |

The specimens fabricated as above are allowed to stand at 23° C. and a relative humidity of 50% for 48 hours, and thereafter the mechanical properties of the specimens are evaluated using the following methods. The results are represented in the following Table 2.

(1) Flame retardancy: Evaluated using 1.5 mm-thick specimens in accordance with UL-94 regulation.

(2) Notched Izod impact strength: Measured using ⅛″ specimens in accordance with ASTM D256 specification.

3 Heat resistance: Evaluated by measuring Vicat softening temperature in accordance with ASTM D1525 specification.

(4) Appearance evaluation of injection moldings: Plate-type specimens having dimensions of vertical and horizontal lengths of 10×10 inches with a thickness ⅛″ are fabricated. Then, the number of silver streaks and pitting formed in the surface of the acquired specimens are observed with the naked eye and evaluated based on the following criteria.

⊚: 0, ∘: less than 10, Δ: less than 11 to 50, x: more than 50

TABLE 2

| | Examples | | Comparative Examples | | | | | |
|---|---|---|---|---|---|---|---|---|
| | 1 | 2 | 1 | 2 | 3 | 4 | 5 | 6 |
| UL 94 flame | V-0 | V-0 | V-2 | V-2 | Fail | V-1 | V-1 | V-2 |
| retardancy | | | | | | | | |
| (1.5 mm) | | | | | | | | |
| Combustion | 34 | 23 | 69 | 78 | — | 54 | 57 | 65 |
| time | | | | | | | | |
| (second) | | | | | | | | |
| ⅛″ IZOD | 64 | 68 | 52 | 65 | 49 | 53 | 63 | 51 |
| impact strength | | | | | | | | |
| (kgf · cm/cm) | | | | | | | | |
| Vicat softening | 141 | 142 | 141 | 141 | 138 | 141 | 142 | 138 |
| temperature | | | | | | | | |
| (° C.) | | | | | | | | |
| appearance | ⊚ | ⊚ | X | ⊚ | Δ | X | ◯ | Δ |

As shown in Table 2, Comparative Examples 1, 2, and 3 include the anti-drip agents D-2, D-3, and D-4, respectively, instead of D-1 of the resin composition of Example 1. Compared to Example 1, Comparative Example 1 has superior heat resistance but shows remarkable deterioration in flame retardancy, impact strength, and appearance characteristics. Comparative Example 2 shows superior appearance, heat resistance, and impact strength, but has remarkably deteriorated flame retardancy. Comparative Example 3 shows remarkable deterioration in flame retardancy, impact strength, heat resistance, and appearance characteristics.

Comparative Examples 4, 5, and 6 use the anti-drip agents D-2, D-3, and D-4, respectively, instead of D-1 of the resin composition of Example 2. Compared to Example 2, Comparative Example 4 has fine heat resistance but it shows remarkable deterioration in flame retardancy, impact strength, and appearance characteristics. Comparative Example 5 has superior appearance, heat resistance, and impact strength characteristics, but shows remarkable deterioration in flame retardancy. Comparative Example 6 shows remarkable deterioration in flame retardancy, impact strength, heat resistance, and appearance characteristics.

The results show that it is, possible to acquire a flame retardant polycarbonate resin composition without deterioration in heat resistance, IZOD impact strength, and appearance characteristics of injection molded products formed using the composition by adding a polycarbonate resin, a rubber-modified vinyl-based graft copolymer, a metal salt of sulfonic acid, and a fluorinated terpolymer mixture in optimal content ranges, compared to a conventional resin composition using an anti-drip agent.

Many modifications and other embodiments of the invention will come to mind to one skilled in the art to which this invention pertains having the benefit of the teachings presented in the foregoing description. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation, the scope of the invention being defined in the claims.

That which is claimed is:

1. A polycarbonate resin composition, comprising:
(A) a polycarbonate resin;
(B) a rubber-modified vinyl-based graft copolymer;
(C) a metal salt of sulfonic acid; and
(D) an anti-drip agent including a fluorinated terpolymer including the repeating unit represented by the following Chemical Formula 1: 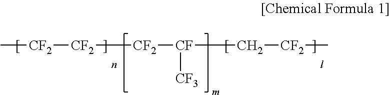
wherein, in the above Chemical Formula 1, each of n, m, and l refers to a mole ratio of the repeating units, n ranges from 15 to 50, m ranges from 20 to 40, and l ranges from 30 to 60.

2. The polycarbonate resin composition of claim 1, wherein the polycarbonate resin composition comprises: 1 to 10 parts by weight of the rubber-modified vinyl-based graft copolymer (B); 0.01 to 3 parts by weight of the metal salt of sulfonic acid (C); and 0.01 to 3 parts by weight of the anti-drip agent including a fluorinated terpolymer including a repeating unit represented by the above Chemical Formula 1, based on 100 parts by weight of the polycarbonate resin (A).

3. The polycarbonate resin composition of claim 1, wherein the vinyl-based graft copolymer is prepared by graft-copolymerizing (b₁) 5 to 95 parts by weight of a vinyl-based monomer into (b₂) 5 to 95 parts by weight of a rubbery polymer,
wherein the vinyl-based monomer (b₁) includes: (b₁₁) 50 to 95 parts by weight of a first vinyl-based monomer comprising styrene, halogen substituted styrene, alkyl substituted styrene, methacrylic acid alkyl ester, acrylic acid alkyl ester, or a mixture thereof; (b₁₂) 5 to 50 parts by weight of a second vinyl-based monomer comprising acrylonitrile, methacrylonitrile, methacrylic acid alkyl ester, acrylic acid alkyl ester, maleic anhydride, C₁-C₄ alkyl N-substituted maleimide, phenyl N-substituted maleimide, or a mixture thereof, and the first and second vinyl-based monomers are different from each other, and
the rubbery polymer (b₂) comprises butadiene rubber, acrylic rubber, ethylene/propylene rubber, styrene/butadiene rubber, acrylonitrile/butadiene rubber, isoprene rubber, ethylene-propylene-diene terpolymer (EPDM), polyorganosiloxane/poly alkylmethacrylate rubber composite, or a mixture thereof.

4. The polycarbonate resin composition of claim 1, wherein the vinyl-based graft copolymer is obtained by graft-copolymerizing a styrene/acrylonitrile vinyl-based monomer, a methacrylic acid alkyl ester monomer, or a mixture thereof, into a butylacrylate rubber.

5. The polycarbonate resin composition of claim 1, wherein the vinyl-based graft copolymer is obtained by graft-copolymerizing a methacrylic acid methyl ester monomer, optionally with an acrylic acid methyl ester or acrylic acid ethyl ester monomer, into an acrylic rubber or polyorganosiloxane/polyalkyl(meth)acrylate rubber polymer.

6. The polycarbonate resin composition of claim 1, wherein the metal salt of sulfonic acid comprises a metal salt of an aromatic sulfonic acid, a metal salt of perfluoroalkanesulfonic acid, or a mixture thereof.

7. The polycarbonate resin composition of claim 6, wherein the metal salt of an aromatic sulfonic acid is represented by the following Chemical Formula 3: 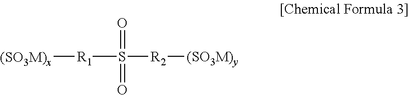
wherein, in the above Chemical Formula 3, R₁ and R₂ are independently a C₁ to C₆ aliphatic group, phenyl, biphenyl, alkyl-substituted phenyl, or a combination thereof, x is an integer ranging from 0 to 6, y is an integer ranging from 1 to 6, and M is a metal cationic group.

8. The polycarbonate resin composition of claim 7, wherein M comprises a Group I metal, Group II metal, copper, aluminum, or a combination thereof.

9. The polycarbonate resin composition of claim 7, wherein the metal salt of an aromatic sulfonic acid comprises a metal salt of diphenylsulfone-3-sulfonic acid, metal salt of diphenylsulfone-3,3′-disulfonic acid, metal salt of diphenylsulfone-3,4′-disulfonic acid, or a mixture thereof.

10. The polycarbonate resin composition of claim 6, wherein the metal salt of perfluoroalkalanesulfonic acid may be represented by the following Chemical Formula 4: 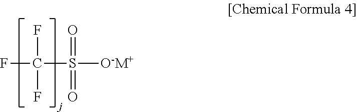
wherein, in the above Chemical Formula 4, M is a metal cationic group, and j is an integer ranging from 1 to 8.

11. The polycarbonate resin composition of claim 10, wherein M comprises a Group I metal, Group II metal, copper, aluminum, or a combination thereof.

12. The polycarbonate resin composition of claim 10, wherein the metal salt of perfluoroalkalanesulfonic acid comprises a metal salt of perfluoromethane sulfonic acid, metal salt of perfluoroethane sulfonic acid, metal salt of perfluoropropane sulfonic acid, metal salt of perfluorobutanesulfonic acid, metal salt of perfluoropentane sulfonic acid, metal salt of perfluorohexane sulfonic acid, metal salt of perfluoroheptane sulfonic acid, metal salt of perfluorooctane sulfonic acid, or a mixture thereof.

13. The polycarbonate resin composition of claim 1, wherein the metal salt of sulfonic acid comprises potassium diphenylsulfone-3-sulfonate, potassium perfluorobutane-sulfonate, or a mixture thereof.

14. The polycarbonate resin composition of claim 1, wherein the anti-drip agent further comprises a fluorinated polyolefin-based resin along with the fluorinated terpolymer.

15. The polycarbonate resin composition of claim 14, wherein the anti-drip agent comprises the fluorinated polyolefin-based resin and fluorinated terpolymer at a weight ratio of 50:50 to 90:10.

16. The polycarbonate resin composition of claim 1, wherein the anti-drip agent has a particle size of 0.05 to 1000 μm.

17. The polycarbonate resin composition of claim 1, wherein the polycarbonate resin composition further comprises an additive comprising an ultraviolet (UV) stabilizer, a fluorescent whitening agent, a lubricant, a release agent, a nucleating agent, an antistatic agent, a stabilizer, a reinforcing material, an inorganic material additive, a pigment, a dye, or mixture thereof.

18. A molded product fabricated using the polycarbonate resin composition according to claim 1.
